(19) United States
(12) Patent Application Publication
(10) Pub. No.: US 2025/0329501 A1
(43) Pub. Date: Oct. 23, 2025

(54) METHOD FOR MANUFACTURING ELECTRONIC COMPONENT, AND ELECTRONIC COMPONENT

(71) Applicant: ELNA CO., LTD., Chuo-ku, Tokyo (JP)

(72) Inventors: Keisuke YONETA, Takasaki-shi (JP); Naozumi KIMURA, Nishishirakawa-gun, Fukushima (JP)

(21) Appl. No.: 18/868,093

(22) PCT Filed: Jun. 14, 2023
(86) PCT No.: PCT/JP2023/022070

§ 371 Date: Nov. 21, 2024

(30) Foreign Application Priority Data
Jun. 23, 2022 (JP) 2022-101060

(51) Int. Cl. H01G 9/00; H01G 9/008

(52) U.S. Cl. CPC H01G 9/0029; H01G 9/008

(57) ABSTRACT

A method for manufacturing an electronic component includes a pressing step in which each lead terminal extending from an electric element is placed between a set of press dies along its length direction and processed into a plate shape, wherein the surface contacting the lead terminal, of at least one of the set of press dies, has been blasted to form recesses and protrusions randomly on the plate face of the plate-shaped lead terminal.

### TECHNICAL FIELD

The present invention relates to a method for manufacturing an electronic component, as well as an electronic component.

### BACKGROUND ART

In the case of a surface-mount type chip electrolytic capacitor, for example, a lead-type electrolytic capacitor is assembled to a seat plate, and a pair of plate-shaped lead terminals led out from the electrolytic capacitor are housed in the groove parts of the seat plate. The lead terminals are press-processed into a strip shape using a pair of press dies (refer to Patent Literatures 1 and 2, for example).

### BACKGROUND ART LITERATURE

### Patent Literature

Patent Literature 1: Japanese Patent Laid-open No. 2019-16761
Patent Literature 2: Japanese Patent Laid-open No. 2020-194978

### SUMMARY OF THE INVENTION

### Problems to be Solved by the Invention

In the press processing of lead terminals, pressing may cause the surface films of the lead terminals to undergo plastic deformation and flow, for example, and the resulting metal powder may allow burrs to generate. If the burrs separate due to vibration or as a result of the lead terminals contacting the holes in the seat plate, for example, and subsequently attach onto the electronic circuit board, short-circuiting or other problems may occur.

With regard to the above, Patent Literatures 1 and 2, for example, disclose techniques for manufacturing lead terminals having multiple convex stripes along the axial direction by press-processing a metal wire material using press dies provided with multiple groove-shaped recessed parts, thereby preventing metal powder residue from generating from the surface films of the lead terminals.

However, the aforementioned techniques may allow metal powder to generate locally in a concentrated manner inside the recessed parts, which makes it difficult to prevent burrs from generating along the recessed parts. It should be noted that this issue is not limited to surface-mount type chip electrolytic capacitors, but is also found in other surface-mount type electronic components having plate-shaped lead terminals.

Accordingly, an object of the present invention, which was made in light of the aforementioned problems, is to provide a method for manufacturing an electronic component that can reduce the generation of burrs on lead terminals, as well as such electronic component.

### Means for Solving the Problems

The method for manufacturing an electronic component proposed by the present invention is characterized in that it includes a pressing step in which each lead terminal extending from an electric element is placed between a set of press dies along its length direction and processed into a plate shape, wherein the surface contacting the lead terminal, of at least one of the set of press dies, has been blasted to form recesses and protrusions randomly on the plate face of the lead terminal.

In the aforementioned method for manufacturing an electronic component, the lead terminal may have a tin plating film.

In the aforementioned method for manufacturing an electronic component, bismuth may have been added to the tin plating film.

In the aforementioned method for manufacturing an electronic component, the arithmetic mean surface roughness of the surface contacting the lead terminal, of at least one of the set of press dies, may be 1.0 to 3.5 μm.

In the aforementioned method for manufacturing an electronic component, the arithmetic mean surface roughness of the surface contacting the lead terminal, of at least one of the set of press dies, may be 1.6 μm.

In the aforementioned method for manufacturing an electronic component, the surface contacting the lead terminal, of at least one of the set of press dies, may have been blasted as mentioned above to bring the arithmetic mean surface roughness of the plate face of the lead terminal to between 1.1 and 2.0 μm.

In the aforementioned method for manufacturing an electronic component, the surface contacting the lead terminal, of at least one of the set of press dies, may have been blasted as mentioned above to bring the 10-point average surface roughness of the plate face of the lead terminal to between 7.0 and 15.0 μm.

In the aforementioned method for manufacturing an electronic component, the electric element may be a capacitor element.

The electronic component proposed by the present invention is characterized in that it comprises an electric element and plate-shaped lead terminals extending from the electric element, wherein recesses and protrusions are formed randomly on the plate faces of the lead terminals.

In the aforementioned electronic component, the lead terminals may have a tin plating film.

In the aforementioned electronic component, bismuth may have been added to the tin plating film.

In the aforementioned electronic component, the arithmetic mean surface roughness of the plate faces of the lead terminals may be 1.1 to 2.0 μm.

In the aforementioned electronic component, the 10-point average surface roughness of the plate faces of the lead terminals may be 7.0 to 15.0 μm.

In the aforementioned electronic component, the electric element may be a capacitor element.

### Effects of the Invention

One aspect of the present invention is that it can reduce the generation of burrs on the lead terminals of electronic components.

### BRIEF DESCRIPTION OF THE DRAWINGS

FIG. 1 A side view showing an example of an aluminum electrolytic capacitor.

FIG. 2 A perspective view showing an example of a capacitor element.

FIG. 3 A flowchart showing an example of a process for manufacturing the aluminum electrolytic capacitor.

FIG. 4 A side view showing an example of a step for pressing the lead terminals.

FIG. 5 A cross-sectional view showing an example of a lead terminal before and after press processing.

FIG. 6 A front view showing an example of how recesses and protrusions are formed on the lead terminal in the pressing step.

FIG. 7 A front view showing an example of a pressing step when multiple groove-shaped recessed parts are provided on the pressing face.

FIG. 8 A diagram showing (a) an image of the pressing face, (b) an image of the measured surface roughness of the lead terminal, (c) an image of the surface of the lead terminal, and (d) an image of a cross-section of the lead terminal, when the outer dies and inner die were not blasted.

FIG. 9 A diagram showing (a) an image of the pressing face, (b) an image of the measured surface roughness of the lead terminal, (c) an image of the surface of the lead terminal, and (d) an image of a cross-section of the lead terminal, when the outer dies and inner die were blasted to Ra=1.6 (μm).

FIG. 10 A diagram showing (a) an image of the pressing face, (b) an image of the measured surface roughness of the lead terminal, (c) an image of the surface of the lead terminal, and (d) an image of a cross-section of the lead terminal, when the outer dies and inner die were blasted to Ra=3.2 (μm).

FIG. 11 A diagram showing images of cross-sections of the lead terminals when the outer dies and inner die (a) were not blasted, (b) were blasted to Ra=1.6 (μm), and (c) were blasted to Ra=3.2 (μm).

FIG. 12 A diagram showing other images of cross-sections of the lead terminals when the outer dies and inner die (a) were not blasted, (b) were blasted to Ra=1.6 (μm), and (c) were blasted to Ra=3.2 (μm).

FIG. 13 A diagram showing examples of images of cross-sections of the lead terminals before and after masking.

### MODE FOR CARRYING OUT THE INVENTION

### Embodiment

### (Structure of Aluminum Electrolytic Capacitor)

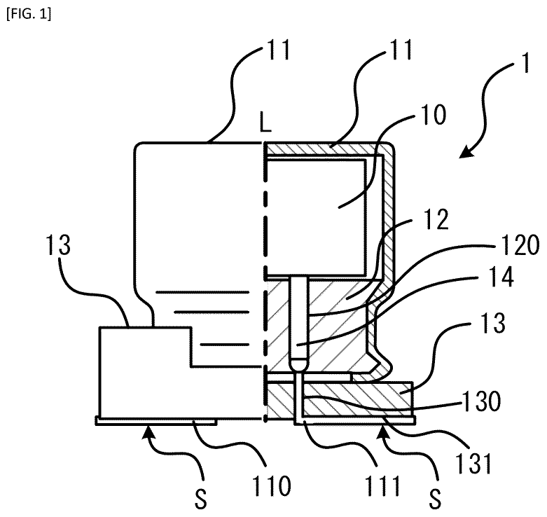

FIG. 1 is a side view showing an example of an aluminum electrolytic capacitor 1. On the page showing FIG. 1, the right half of the aluminum electrolytic capacitor 1, when cut along the centerline L, shows a cross-section of the interior thereof.

The aluminum electrolytic capacitor 1 is an example of an electronic component. In this example, a conductive polymer hybrid aluminum electrolytic capacitor is specifically cited as the aluminum electrolytic capacitor 1; however, it is not limited to this example. The aluminum electrolytic capacitor 1 is mounted on an electronic circuit board and used for coupling, decoupling, smoothing, or the like, for example.

The aluminum electrolytic capacitor 1 comprises a capacitor element 10, a case 11, a sealing body 12, a seat plate 13, a pair of terminal parts 14, and lead terminals 110, 111. It should be noted that, while FIG. 1 shows only one terminal part 14, the other terminal part 14 is provided at a symmetrical position across the centerline L.

The case 11 is formed by aluminum and has a cylindrical shape with its top opening closed. The case 11 covers the capacitor element 10 and sealing body 12 and functions as an outer sheath of the aluminum electrolytic capacitor 1. It should be noted that the shape of the case 11 is not limited to a cylindrical shape and may be a polygonal cylinder shape.

The sealing body 12 is a roughly circular member formed by butyl rubber or other elastic material, for example. The sealing body 12 adjoins the capacitor element 10 and seals the open end of the case 11.

The capacitor element 10 has a structure where an anode foil, a cathode foil, and a separator (electrolytic paper), are stacked and wound together, as described later. A pair of terminal parts 14 extends from the bottom part of the capacitor element 10.

The pair of terminal parts 14 and lead terminals 110, 111 are bar-like members formed by aluminum, etc. The pair of terminal parts 14 is joined to the anode foil and cathode foil, respectively, by caulking or other joining means, and function as an anode terminal and a cathode terminal of the aluminum electrolytic capacitor 1. The terminal parts 14 are inserted through a pair of through holes 120, respectively, that are formed in the sealing body 12. It should be noted that, while FIG. 1 only shows one through hole 120, the other through hole 120 is provided at a symmetrical position across the centerline L.

Plate-shaped lead terminals 110, 111 are provided at the tips of the pair of terminal parts 14, respectively. The lead terminals 110, 111 are bent into the shape of the letter L and their tip-side parts extend along the plate face of the seat plate 13. The parts, on the terminal part 14 side, of the lead terminals 110, 111 are inserted through through-holes 130 in the seat plate 13. The lead terminals 110, 111 are soldered to pads on an electronic circuit board in the electronic circuit board reflow process.

The seat plate 13 is a plate-shaped member formed by resin, etc., and provided underneath the case 11 and sealing body 12. The seat plate 13 supports the case 11 and sealing body 12 on the electronic circuit board which is a mounting target. Provided in the seat plate 13 are through holes 130 for the lead terminals 110, 111 as well as groove parts 131 in which to house the bent tip parts of the lead terminals 110, 111. The groove parts 131 extend outward from near the center, along the bottom face, of the seat plate 13. The bottom face of the seat plate 13 becomes a mounting face of the aluminum electrolytic capacitor 1 on an electronic circuit board, allowing the plate-shaped lead terminals 110, 111 to be soldered to the pads on the electronic circuit board.

### (Configuration of Capacitor Element)

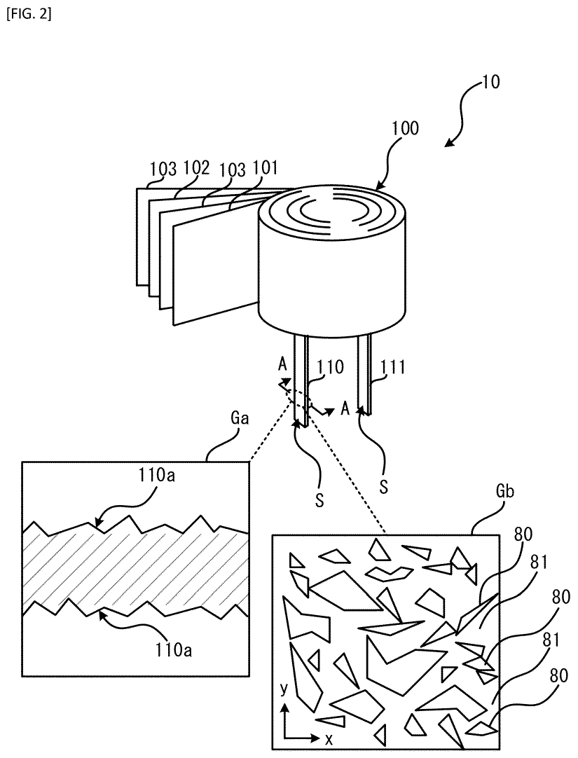

FIG. 2 is a perspective view showing an example of the capacitor element 10. In FIG. 2, the components identical to those in FIG. 1 are denoted by the same symbols and not explained. The capacitor element 10 is an example of an electric element and comprises a wound body 100 consisting of an anode foil 101, a cathode foil 102, and a separator (electrolytic paper) 103, that have been wound together.

Extending downward from the wound body 100 are the pair of lead terminals 110, 111. The lead terminals 110, 111 are connected to the anode foil 101 and cathode foil 102, respectively. It should be noted that, in FIG. 2, the lead terminals 110, 111 are shown in a state before bending.

The anode foil 101 and cathode foil 102 are formed by, for example, aluminum, tantalum, titanium, niobium, or other valve metal, or alloy foil or vapor-deposited foil thereof, or the like. The surface of the anode foil 101 is etched to increase the electrode area. Additionally, an extremely thin oxide film is formed on the surface of the anode foil 101. As a result, the anode foil 101 is insulated from other members. As the oxide film functions as a dielectric body, the capacitor element 10 functions as a capacitor.

By contrast, the surface of the cathode foil 102 is etched but no oxide film is formed thereon. It should be noted that the surface of the cathode foil 102 may be etched. Also, an oxide film may be formed, or an inorganic layer or carbon layer may be formed, on the surface of the cathode foil 102.

The separator 103 is wound in a state of being placed between the anode foil 101 and cathode foil 102. The separator 103 uses at least one type, or more types, of materials selected from cellulose, rayon, glass fiber, and the like. The separator 103 is impregnated with an electrolytic solution and a conductive polymer. It should be noted that, if the aluminum electrolytic capacitor 1 is not a conductive polymer hybrid capacitor, no conductive polymer is used.

In the process for manufacturing the aluminum electrolytic capacitor 1, the lead terminals 110, 111 are press-processed into a plate shape from a round bar shape using press dies. As a result, the lead terminals 110, 111 assume a flat shape that supports surface mounting onto an electronic circuit board. In this pressing step, recesses and protrusions are formed randomly on the plate faces S of the lead terminals 110, 111 using blasted press dies as described later.

An example of a cross-section of the lead terminal 110 along line A-A is schematically illustrated under the symbol Ga. Recesses and protrusions 110a are formed randomly on the plate faces S of the lead terminal 110. The recesses and protrusions 110a on the plate faces S of the lead terminal 110 do not have directionality as grooves do, and their height and orientation are random. Also, the recesses and protrusions 110a on the plate faces S of the lead terminal 110 are schematically illustrated in plan view under the symbol Gb. Here, x represents the width direction of the lead terminal 110 and y represents the length direction of the lead terminal 110. On the plate faces S, many randomly shaped protruding parts 80 and recessed parts 81 are formed. The placement of the protruding parts 80 and recessed parts 81 has no regularity and the protruding parts 80 and recessed parts 81 are arranged not in set directions, but in random two-dimensional directions. This means that the plate faces S have no grooves running in set directions formed on them. These recesses and protrusions 110a are transferred, in the pressing step, from the surfaces of the blasted press dies onto the lead terminal 110. It should be noted that, although not illustrated, similar random recesses and protrusions are formed on the plate faces S of the other lead terminal 111.

### (Process for Manufacturing Aluminum Electrolytic Capacitor)

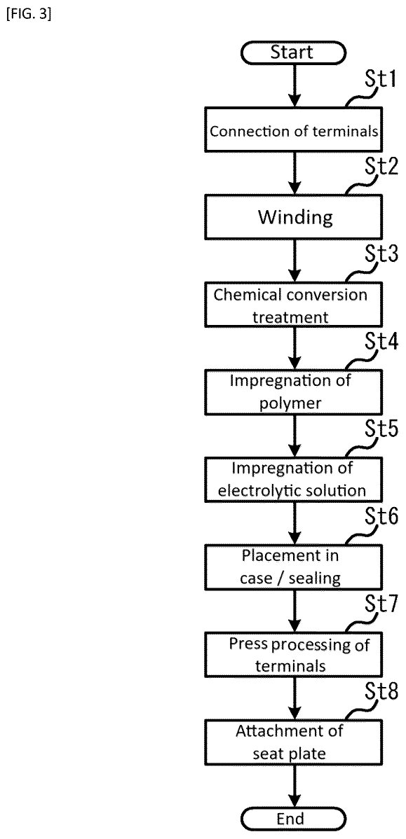

FIG. 3 is a flowchart showing an example of a process for manufacturing the aluminum electrolytic capacitor 1. The process for manufacturing the aluminum electrolytic capacitor 1 represents an example of a method for manufacturing an electronic component.

First, terminal parts 14 are connected to an anode foil 101 and a cathode foil 102, respectively, that have been prepared beforehand (step St1). The connection means include, but are not limited to, caulking.

Next, a separator 103, the anode foil 101, the cathode foil 102, and a separator 103, are stacked in this order and wound together, and the outer surface is secured with a winding-head fixing tape to produce a wound body 100 (step St2).

Next, the wound body 100 is given a chemical conversion treatment (step St3). This repairs the defects in the oxide film formed on the surface of the anode foil 101. The chemical conversion treatment uses, for example, a chemical conversion solution prepared by dissolving in an organic solvent or inorganic solvent a carboxylic acid group-containing organic acid salt, phosphoric acid or other inorganic acid salt, or other solute.

Next, in a reduced-pressure atmosphere, the wound body 100 is immersed for 20 minutes in a conductive polymer dispersion liquid containing water and organic solvent, after which the wound body 100 is pulled out of the conductive polymer dispersion liquid (step St4). This way, a conductive polymer can be impregnated into the wound body 100.

Next, in a reduced-pressure atmosphere, a prescribed amount of electrolytic solution is impregnated into the wound body 100 (step St5). It should be noted that the electrolytic solution may be one prepared by mixing a solute into the conductive polymer dispersion liquid. In other words, the conductive polymer dispersion liquid can be used as the electrolytic solution. In this case, the impregnation of the electrolytic solution is performed simultaneously as the impregnation of the conductive polymer. Now, the capacitor element 10 is complete. It should be noted that, if no conductive polymer is to be used in the capacitor element 10, steps St3 and St4 can be omitted.

Next, the wound body 100 is housed in the case 11 and sealed with the sealing body 12 (step St6). At this time, the terminal parts 14 extending from the wound body 100 are inserted through the through holes 120 in the sealing body 12. Thereafter, the capacitor element 10 may be aged by applying the rated voltage.

Next, the lead terminals 110, 111 are press-processed into a plate shape with a set of press dies sandwiching them along their length direction (step St7). Consequently, the lead terminals 110, 111 are press-processed into having a cross-sectional shape that is no longer a round shape, but a plate shape according to the press dies, to support surface mounting on an electronic circuit board. In this pressing step, recesses and protrusions are formed randomly on the plate faces S of the lead terminals 110, 111. It should be noted that the details of the pressing step are described later.

Next, the seat plate 13 is attached to the case 11 (step St8). At this time, the lead terminals 110, 111 are inserted through the through holes 130 in the seat plate 13, cut to an appropriate length, and bent into the shape of the letter L. The bent tip parts of the lead terminals 110, 111 are housed in the groove parts 131 provided on the bottom face of the seat plate 13. Now, the aluminum electrolytic capacitor 1 is complete.

### (Pressing Step)

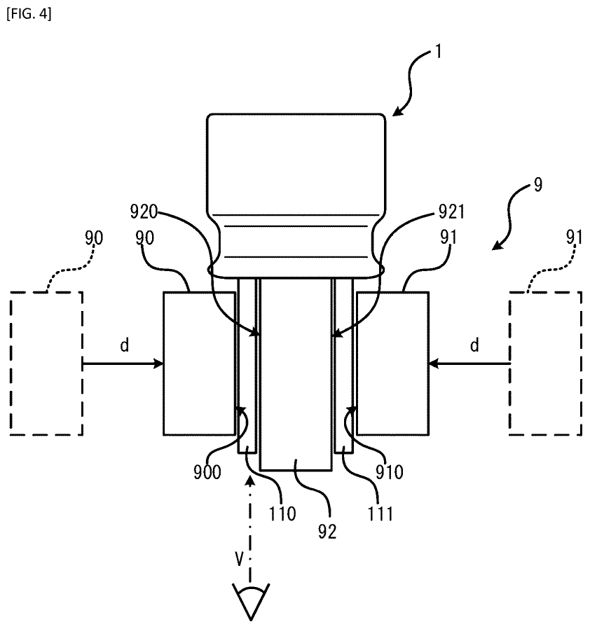

FIG. 4 is a side view showing an example of a step for pressing the lead terminals 110, 111. A press device 9 comprises a set of outer dies 90, 91 and inner die 92 as press dies. The outer dies 90, 91 and inner die 92 are metal members of roughly rectangular solid shape, for example, and have a hardness higher than the cores of the lead terminals 110, 111.

The outer dies 90, 91 are arranged on opposite sides to each other with the inner die 92 in between. The aluminum electrolytic capacitor 1 is transferred by an arm device, etc., for example, and held at such position that the lead terminals 110, 111 are on both sides of the inner die 92. The outer dies 90, 91 move horizontally to each other toward the inner die 92 as illustrated by the symbol d.

This causes the lead terminals 110, 110 to become placed between the outer dies 90, 91 and inner die 92 along their length direction. At this time, a pressing face 920 of the inner die 92 and pressing face 900 of the outer die 90 are in contact with one lead terminal 110, while a pressing face 921 of the inner die 92 and pressing face 910 of the outer die 91 are in contact with the other lead terminal 111. The pressing time, which is desirably short so that burrs will be smaller in size, is 0.01 (sec) or less, for example.

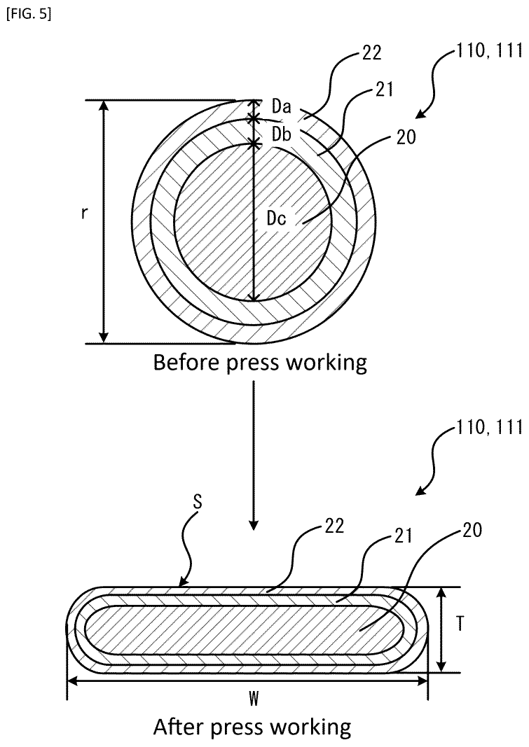

FIG. 5 is a cross-sectional view showing an example of the lead terminals 110, 111 before and after press processing. FIG. 5 shows the cross-section along line A-A in FIG. 2.

The lead terminals 110, 111 have a three-layer structure, for example. The lead terminals 110, 111 comprise a wire core layer 20, a coating layer 21, and a plating layer 22. The wire core layer 20 is the core of the wire material constituting the lead terminals 110, 111 and formed by iron, for example. The coating layer 21 is a coating film covering the wire core layer 20 and formed by copper, for example.

The plating layer 22 is formed by tin, for example, in order to improve the adhesion with the solder in the reflow process. The plating layer 22 is an example of a tin plating film. Here, the plating layer 22 may be formed by adding bismuth to the tin. Adding bismuth prevents production of whiskers (whisker crystals) in the plating layer 22. Also, the hardness of the plating layer 22 is lower than that of the outer dies 90, 91 and inner die 92.

Although the cross-sectional shape of the lead terminals 110, 111 before press processing is roughly a circular shape, the cross-sectional shape of the lead terminals 110, 111 after press processing is roughly a strip shape. Press processing causes the plating layer 22 on the outermost side to undergo plastic deformation, and because the plating layer 22 flows as a result, burrs are generated.

TABLE 1

| | | Wire core layer | Coating layer | Plating layer |
|---|---|---|---|---|
| | Wire diameter r | thickness Dc | thickness Db | thickness Da |
| | (mm) | (μm) | (μm) | (μm) |
| No. 1 | 0.45 | 370-390 | 18-28 | 9-15 |
| No. 2 | 0.6 | 500-520 | 25-35 | 9-15 |
| No. 3 | 0.8 | 680-700 | 36-46 | 9-15 |

Table 1 above shows the thicknesses Da to Dc of the respective layers of the lead terminals 110, 111 before press processing, for each type of lead terminals 110, 111 from Nos. 1 to 3. The wire diameter r is different among the lead terminals 110, 111 of Nos. 1 to 3. The greater the wire diameter r, the greater the wire core layer 20 thickness Dc and coating layer 21 thickness Db become. Meanwhile, the thickness Da of the plating layer 22 is the same for Nos. 1 to 3.

TABLE 2

| | Lead terminal | Lead terminal |
|---|---|---|
| | thickness T (μm) | width W (μm) |
| No. 1 | 0.2-0.25 | 0.65-0.7 |
| No. 2 | 0.3-0.35 | 0.8-0.9 |
| No. 3 | 0.4-0.45 | 1.2-1.3 |

Table 2 above shows the sizes of the lead terminals 110, 111 of Nos. 1 to 3 in Table 1 after press processing. The greater the wire diameter r of the lead terminals 110, 111, the greater their thickness T and width W become.

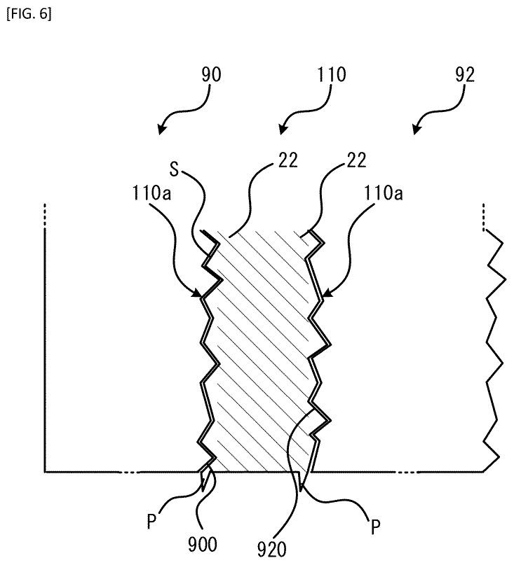

FIG. 6 is a front view showing an example of how recesses and protrusions 110a are formed on the lead terminal 110 in the pressing step. In FIG. 6, the components identical to those in FIGS. 1 and 4 are denoted by the same symbols and not explained. Specifically, FIG. 6 shows a part of how the tip of the lead terminal 110 looks as viewed from the front when the outer die 90 and inner die 92 are sandwiching the lead terminal 110 as indicated by the symbol d in FIG. 4 (refer to the symbol V in FIG. 4).

The pressing face 920 of the inner die 92 and pressing face 900 of the outer die 90 have been blasted beforehand to a prescribed surface roughness. The shapes of the media (polishing material) used for blasting include, but are not limited to, amorphous and spherical shapes. Also, the surface roughness of each pressing face 900 or 920 after blasting should be 1.6 based on Ra (arithmetic mean surface roughness). However, the Ra after blasting is not limited to this and may be 1.0 to 3.5 (μm), or preferably 1.1 to 2.0 (μm).

As a result of blasting, recesses and protrusions are formed randomly on the pressing faces 900, 920. Since the hardness of the inner die 92 and outer die 90 is higher than that of the plating layer 22, effectively the recesses and protrusions on the pressing faces 900, 920 of the inner die 92 and outer die 90 are transferred onto the lead terminal 110. This means that, as a result of the pressing faces 900, 920 pressing against the lead terminal 110, a plate face S having random recesses and protrusions 110a is formed. Here, the Ra of the recesses and protrusions 110a is 1.1 to 2.0 (μm). Also, the Rz (10-point average surface roughness) of the recesses and protrusions 110a is 7.0 to 15.0 (μm). It should be noted that Ra and Rz are specified in “JIS (Japan Industrial Standards) B 0601 (1994)” and “JIS B 0031 (1994).”

As described above, press processing causes the plating layer 22 to undergo plastic deformation and flow to the edge parts of the plating layer 22, and burrs P are formed as a result. However, since the random recesses and protrusions on the pressing faces 900, 920 reduce the flow of the plating layer 22, the generation of burrs P is reduced compared to when the pressing faces 900, 920 were not blasted. It should be noted that, while one lead terminal 110 is illustrated in this example, the generation of burrs P is also reduced in the same manner described above on the other lead terminal 111. Additionally, while recesses and protrusions by blasting are provided on both pressing faces 900, 910, 920 of the outer dies 90, 91 and inner die 92 in this example, recesses and protrusions may be provided on only one pressing face 900, 910, 920 of the outer dies 90, 91 and inner die 92.

If, unlike in this embodiment, multiple groove-shaped recessed parts are provided on the pressing faces 900, 910, 920 in the same manner described in Patent Literature 1 mentioned above, burrs may increase as described below.

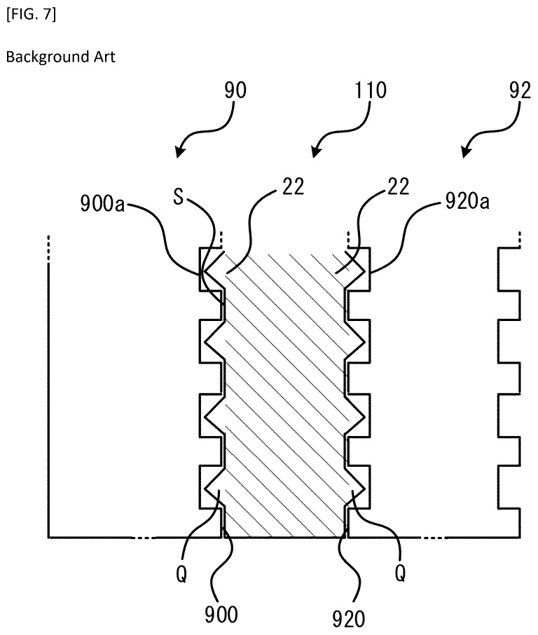

FIG. 7 is a front view showing an example of a pressing step when multiple groove-shaped recessed parts 900a, 920a are provided on the pressing faces 900, 920. In FIG. 7, the components identical to those in FIGS. 1 and 4 are denoted by the same symbols and not explained. Specifically, FIG. 7 shows a part of how the tip of the lead terminal 110 looks as viewed from the front (see symbol V in FIG. 4) when the outer die 90 and inner die 92 are sandwiching the lead terminal 110 as indicated by the symbol d in FIG. 4.

Multiple groove-shaped recessed parts 900a, 920a are provided on the pressing faces 900, 920. The direction in which the recessed parts 900a, 920a extend follows the length direction of the lead terminal 110.

As the pressing faces 900, 920 press against the lead terminal 110, the metal powder in the plating layer 22 may flow locally in a concentrated manner into the recessed parts 900a, 920a. As a result, and contrary to this embodiment, many burrs Q may generate, in addition to protruding strips, on the plate face S of the lead terminal 110 along the recessed parts 900a, 920a.

### EXAMPLES

Next, examples of methods for manufacturing the aluminum electrolytic capacitor 1 are explained. In these examples, a pressing step was implemented by blasting the pressing faces 900, 910, 920 of the outer dies 90, 91 and inner die 92 so that an Ra of 1.6 (μm) or 3.2 (μm) was achieved. Also, for the purpose of comparison, a pressing step using non-blasted outer dies 90, 91 and inner die 92 was also implemented. In this case, the Ra of the pressing faces 900, 910, 920 was set to 0.5 (μm) or lower. It should be noted that, for the media for blasting, a spherical media corresponding to the target Ra was used. Also, the thicknesses Da to Dc of the respective layers in the lead terminals 110, 111 are as shown in Table 1.

TABLE 3

| | Not blasted | | Blasted | | Blasted | |
|---|---|---|---|---|---|---|
| | (Ra ≤ 0.5 μm) | | (Ra = 1.6 μm) | | (Ra = 3.2 μm) | |
| | Lead | Lead | Lead | Lead | Lead | Lead |
| | terminal | terminal | terminal | terminal | terminal | terminal |
| | Ra (μm) | Rz (μm) | Ra (μm) | Rz (μm) | Ra (μm) | Rz (μm) |
| No. 1 | 0.316 | — | 1.239 | 11.31 | 3.101 | 25.167 |
| No. 2 | 0.385 | — | 1.442 | 12.126 | 3.187 | 20.927 |
| No. 3 | 0.228 | — | 1.259 | 7.95 | 2.579 | 17.835 |
| No. 4 | 0.4 | — | 1.293 | 12.371 | 2.331 | 18.201 |
| No. 5 | 0.354 | — | 1.462 | 11.526 | 3.202 | 24.524 |
| No. 6 | — | — | 1.117 | 9.315 | 2.786 | 19.594 |
| No. 7 | — | — | 1.958 | 13.539 | 3.664 | 27.237 |
| No. 8 | — | — | 1.851 | 13.156 | 2.998 | 21.56 |
| No. 9 | — | — | 1.659 | 13.896 | 3.363 | 22.514 |
| No. 10 | — | — | 1.436 | 12.108 | 2.953 | 18.696 |
| Average | 0.337 | — | 1.4716 | 11.7297 | 3.0164 | 21.6255 |

Table 3 shows the Ra's and Rz's, and their averages, of the multiple samples of the press-processed lead terminals 110, 111 when the outer dies 90, 91 and inner die 92 were not blasted, when they were blasted to Ra=1.6 (μm), and when they were blasted to Ra=3.2 (μm). Under the condition where the dies were not blasted, Ra was measured on the plate faces S of five lead terminal 110, 111 samples from Nos. 1 to 5. Under the conditions where the dies were blasted to Ra=1.6 (μm) and to Ra=3.2 (μm), Ra and Rz were measured on the plate faces S of 10 lead terminal 110, 111 samples from Nos. 1 to 10.

Of the samples Nos. 1 to 5 associated with the non-blasted dies, Nos. 4 and 5 represent lead terminals 110, 111 whose plating layer 22 had bismuth added to it, while Nos. 1, 2, and 3 represent lead terminals 110, 111 whose plating layer 22 had no bismuth added to it. Of the samples Nos. 1 to 10 from the dies blasted to Ra=1.6 (μm), Nos. 4, 5, 6, 9, and 10 represent lead terminals 110, 111 whose plating layer 22 had bismuth added to it, while Nos. 1, 2, 3, 7, and 8 represent lead terminals 110, 111 whose plating layer 22 had no bismuth added to it. Of the samples Nos. 1 to 10 from the dies blasted to Ra=3.2 (μm), Nos. 4, 5, 6, 9, and 10 represent lead terminals 110, 111 whose plating layer 22 had bismuth added to it, while Nos. 1, 2, 3, 7, and 8 represent lead terminals 110, 111 whose plating layer 22 had no bismuth added to it.

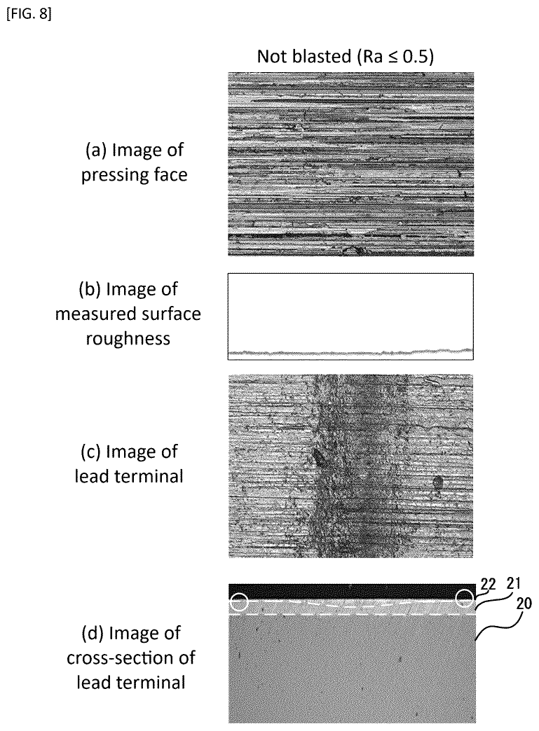

FIG. 8 is a diagram showing (a) an image of the pressing face 900, 910, 920, (b) an image of the measured surface roughness of the lead terminal 110 or 111, (c) an image of the surface of the lead terminal 110, 111, and (d) an image of a cross-section of the lead terminal 110, 111, when the outer dies 90, 91 and inner die 92 were not blasted. In the (d) image of a cross-section of the lead terminal 110, 111, the dotted lines indicate the boundaries of the plating layer 22, coating layer 21, and wire core layer 20. It should be noted that the images were captured using a laser microscope.

When the dies were not blasted, the surface recesses and protrusions on the pressing face 900, 910, 920 and lead terminal 110, 111 were small. Also, in the pressing step, the plating layer 22 hardly flowed and its thickness remained at 8 (μm) at the center; at both ends (refer to the circles), however, the plating layer 22 flowed considerably and its thickness halved to 3 to 4 (μm). This flowing caused burrs to generate at the end parts of the lead terminal 110 or 111.

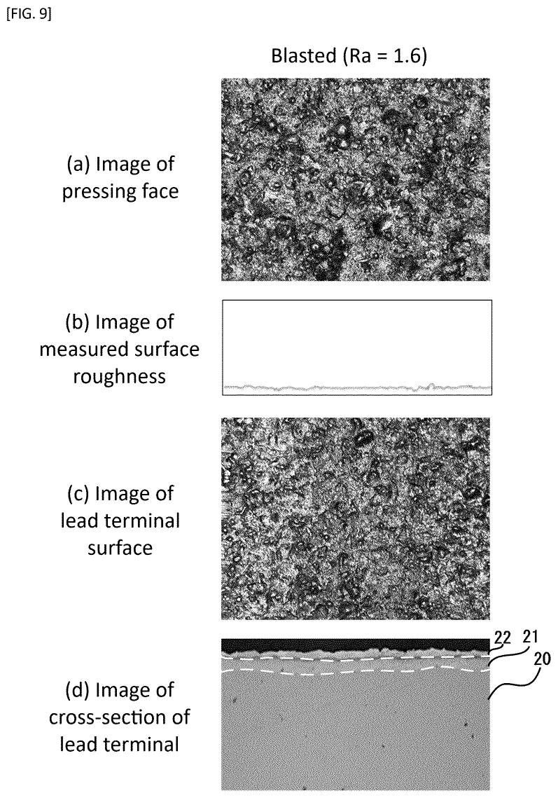

FIG. 9 is a diagram showing (a) an image of the pressing face 900, 910, 920, (b) an image of the measured surface roughness of the lead terminal 110, 111, (c) an image of the surface of the lead terminal 110, 111, and (d) an image of a cross-section of the lead terminal 110, 111, when the outer dies 90, 91, and inner die 92 were blasted to Ra=1.6 (μm). In the (d) image of a cross-section of the lead terminal 110, 111, the dotted lines indicate the boundaries of the plating layer 22, coating layer 21, and wire core layer 20. It should be noted that the images were captured using a laser microscope.

When the dies were blasted to Ra=1.6 (μm), recesses and protrusions with random heights and orientations that do not have directionality as grooves do were formed on the surfaces of the pressing face 900, 910, 920 and lead terminal 110 or 111. The random recesses and protrusions on the pressing face 900, 910, 920 allowed the degrees of flowing of the plating layer 22 at the surface to average out all around, resulting in an overall layer thickness of 8 to 12 (μm). This reduced the generation of burrs compared to when the dies were not blasted.

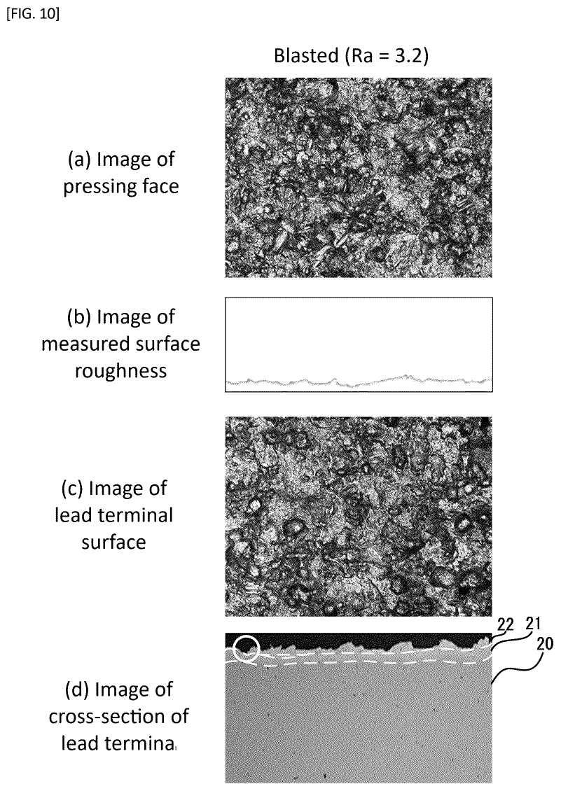

FIG. 10 is a diagram showing (a) an image of the pressing face 900, 910, 920, (b) an image of the measured surface roughness of the lead terminal 110, 111, (c) an image of the surface of the lead terminal 110, 111, and (d) an image of a cross-section of the lead terminal 110, 111, when the outer dies 90, 91, and inner die 92 were blasted to Ra=3.2 (μm). In the (d) image of a cross-section of the lead terminal 110, 111, the dotted lines indicate the boundaries of the plating layer 22, coating layer 21, and wire core layer 20. It should be noted that the images were captured using a laser microscope.

When the dies were blasted to Ra=3.2 (μm), recesses and protrusions with random heights and orientations that do not have directionality as grooves do were formed on the surfaces of the pressing face 900, 910, 920 and lead terminal 110, 111. The recesses and protrusions were larger in size compared to when the dies were blasted to Ra=1.6 (μm). The random recesses and protrusions on the pressing face 900, 910, 920 average the flowability of metal powder on the surface of the plating layer 22, resulting in an overall layer thickness of 2 to 20 (μm). This reduced the generation of burrs compared to when the dies were not blasted; however, the thickness variation was greater compared to when the dies were blasted to Ra=1.6 (μm), and the coating layer 21 on the interior side of the plating layer 22 was exposed in one area (see the circle) as a result.

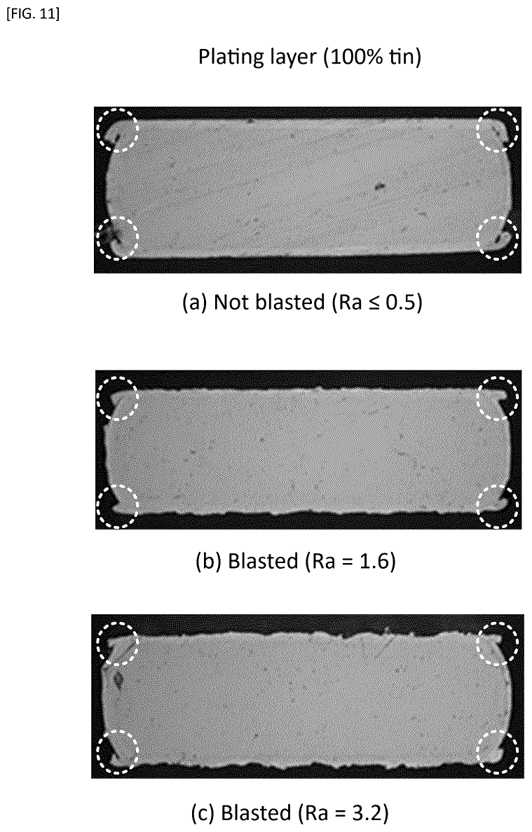

FIG. 11 is a diagram showing images of cross-sections of the lead terminals 110, 111 when the outer dies 90, 91, and inner die 92 (a) were not blasted, (b) were blasted to Ra=1.6 (μm), and (c) were blasted to Ra=3.2 (μm). Each cross-section corresponds to the cross-section along line A-A in FIG. 2. Also, the plating layer 22 had a compositional makeup of 100(%) tin.

The circles show the burrs generated in the pressing step. As understood from FIG. 11, the burrs were the largest when the dies were not blasted and the smallest when the dies were blasted to Ra=3.2 (μm).

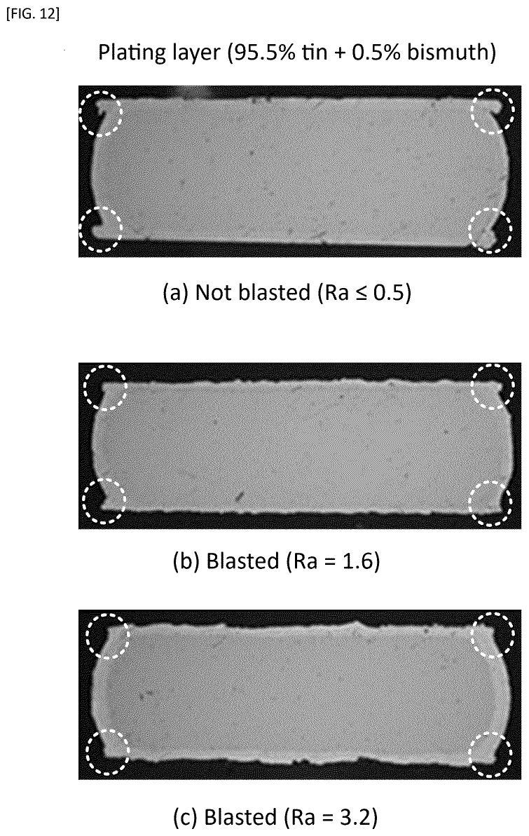

FIG. 12 is a diagram showing other images of cross-sections of the lead terminals 110, 111 when the outer dies 90, 91 and inner die 92 (a) were not blasted, (b) were blasted to Ra=1.6 (μm), and (c) were blasted to Ra=3.2 (μm). Each cross-section corresponds to the cross-section along line A-A in FIG. 2. It should be noted that the images were captured using a laser microscope. In this example, the plating layer 22 had a compositional makeup of 99.5(%) tin and 0.5(%) bismuth.

The circles in dotted lines show the burrs generated in the pressing step. As understood from FIG. 12, burrs generated in a manner extending outward along the plate faces of the lead terminals 110, 111 as a result of the metal powder constituting the plating layer 22 flowing outward on both end sides of the lead terminals 110, 111. The burrs were the largest when the dies were not blasted and the smallest when the dies were blasted to Ra=3.2 (μm). The above images were masked to quantitatively measure the size of the burrs.

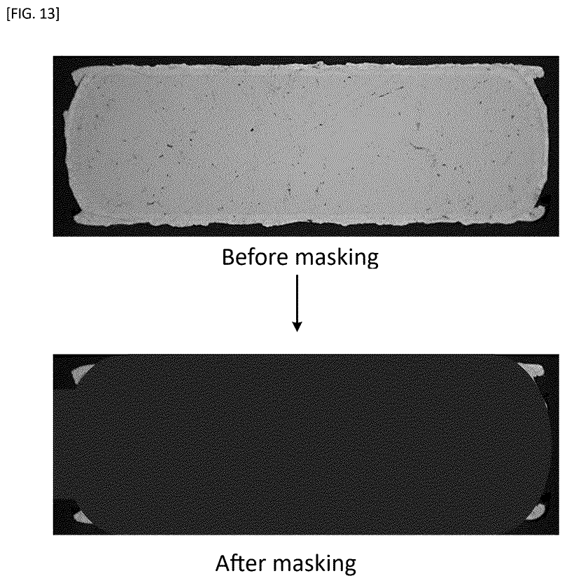

FIG. 13 is a diagram showing examples of images of cross-sections of the lead terminals 110, 111 before and after masking. After masking the images except for the burred regions in the four corners of the lead terminals 110, 111, the total pixels were measured.

TABLE 4

| | Total pixels in burred regions | | |
|---|---|---|---|
| Bismuth | Not blasted | Blasted | Blasted |
| content | (Ra ≤ 0.5 μm) | (Ra = 1.6 μm) | (Ra = 3.2 μm) |
| 0(%) | 3384 | 2051 | 1496 |
| 0.5(%) | 2337 | 1288 | 1228 |

Table 4 shows the total pixels in the burred regions. The pixels were measured on the lead terminals 110, 111 not containing bismuth and lead terminals 110, 111 containing 0.5(%) of bismuth. Also, they were measured under the conditions where the outer dies 90, 91 and inner die 92 were not blasted, were blasted to Ra=1.6 (μm), and were blasted to Ra=3.2 (μm). It should be noted that the measured results are shown as averages of the lead terminal 110, 111 samples listed in Table 3.

Regardless of whether or not bismuth was contained, the pixels decreased when the outer dies 90, 91 and inner die 92 were blasted, compared to when they were not blasted. When the dies were blasted to Ra=1.6 (μm), the pixels in the burred regions of the lead terminals 110, 111 whose plating layer 22 did not contain bismuth decreased by approx. 40(%), while the pixels in the burred regions of the lead terminals 110, 111 whose plating layer 22 contained bismuth decreased by approx. 45(%). Also, when the dies were blasted to Ra=3.2 (μm), the pixels in the burred regions of the lead terminals 110, 111 whose plating layer 22 did not contain bismuth decreased by approx. 56(%), while the pixels in the burred regions of the lead terminals 110, 111 whose plating layer 22 contained bismuth decreased by approx. 47(%).

Additionally, when the dies were blasted to Ra=3.2 (μm), the pixels decreased compared to when they were blasted to Ra=1.6 (μm). This, as described above, is because blasting the dies to Ra=3.2 (μm) increased the surface roughness of the lead terminals 110, 111.

Regardless of whether or not the dies were blasted, the pixels in the burred regions of the lead terminals 110, 111 whose plating layer 22 contained bismuth were fewer than the pixels in the burred regions of the lead terminals 110, 111 whose plating layer 222 did not contain bismuth. This is because the bismuth content raised the hardness of the tin plating, making it difficult for the plating itself to flow.

Also, a comparison of the pixels in the burred regions of the lead terminals 110, 111 whose plating layer 22 contained bismuth and those of the lead terminals 110, 111 whose plating layer 22 did not contain bismuth finds that the difference was small under the condition associated with Ra=1.6 (μm) and Ra=3.2 (μm). This is because the higher hardness of the tin plating layer resulting from the bismuth content made it easier for the pressing force to transmit to the wire core layer 20.

Thus, by, in the pressing step, sandwiching the lead terminals 110, 111 with the outer dies 90, 91 and inner die 92 whose pressing faces 900, 910, 920 have been blasted and thereby forming recesses and protrusions randomly on their plate faces S, the generation of burrs can be reduced. At this time, blasting the pressing faces 900, 910, 920 to Ra=3.2 (μm) may cause the coating layer 21 to be exposed as shown in the image in FIG. 10 (d).

For this reason, preferably the pressing faces 900, 910, 920 are blasted to Ra=1.6 (μm). This means that, based on the Ra and Rz of the lead terminals 110, 111 shown in Table 3, preferably the pressing faces 900, 910, 920 are blasted so that the Ra of their plate face S falls between 1.1 and 2.0 (μm) or the Rz of their plate face S falls between 7.0 and 15.0 (μm). This prevents the plating layer 22 from peeling and consequently exposing the coating layer 21 on the interior side.

Additionally, by implementing the pressing step using multiple types of media for blasting, the lead terminals 110, 111 were evaluated for size of burrs and exposure/non-exposure of the coating layer 21.

TABLE 5

| | Media used for blasting | | | | |
|---|---|---|---|---|---|
| | N/A (Not | Amorphous | Amorphous | Spherical | Spherical |
| | blasted) | (Ra = 1.6 μm) | (Ra = 3.2 μm) | (Ra = 1.6 μm) | (Ra = 3.2 μm) |
| Press die Ra | 0.5(μm) | 1.682(μm) | 4.013(μm) | 1.401(μm) | 2.884(μm) |
| | or less | | | | |
| Lead terminal | 0.228(μm) | 1.542(μm) | 3.363(μm) | 1.259(μm) | 3.101(μm) |
| Ra (bismuth | | | | | |
| not added) | | | | | |
| Lead terminal | 0.207(μm) | 1.846(μm) | 3.409(μm) | 1.462(μm) | 2.786(μm) |
| Ra (bismuth | | | | | |
| added) | | | | | |
| Coating layer | No | No | Yes | No | Yes |
| exposure | | | | | |
| Burrs | Large | Small | Small | Small | Small |

Table 5 shows the evaluation results, for each media used for blasting, of the size of burrs and exposure/non-exposure of the coating layer 21 on the lead terminals 110, 111. For the media, an amorphous media corresponding to Ra=1.6 (μm), an amorphous media corresponding to Ra=3.2 (μm), a spherical media corresponding to Ra=3.2 (μm), and a spherical media corresponding to Ra=1.6 (μm), were used. Also, for the purpose of comparison, the lead terminals 110, 111 associated with the non-blasted dies were also evaluated (refer to “N/A”). It should be noted that, under each condition, 10 lead terminals 110, 111 were evaluated as samples.

Also, Table 5 shows the measurement results, for each media, of the Ra of the outer dies 90, 91 and inner die 92 (press dies), Ra of the lead terminals 110, 111 whose plating layer 22 had no bismuth added to it, and Ra of the lead terminals 110, 111 whose plating layer 22 had bismuth added to it. It should be noted that the bismuth content was set to the same 0.5(%) as above.

Regardless of which media was used, the size of burrs decreased compared to when the dies were not blasted. Also, while exposure of the coating layer 21 was not noted when the amorphous media and spherical media corresponding to Ra=1.6 (μm) were used, exposure of the coating layer 21 was noted both when the amorphous media and spherical media corresponding to Ra=3.2 (μm) were used. In the latter cases, the Ra of the outer dies 90, 91 and inner die 92 (press dies) became larger than when the amorphous media and spherical media corresponding to Ra=1.6 (μm) were used, resulting in a deeper shaving of the plating layer 22.

Therefore, use of the amorphous media and spherical media corresponding to Ra=1.6 (μm) prevented exposure of the coating layer 21.

It should be noted that, while the evaluations were made using the lead terminals 110, 111 whose plating layer 22 had a thickness of 9 to 15 (μm), the thickness is not limited to the foregoing. Ideally the blasting Ra is set as deemed appropriate according to the thickness of the plating layer 22.

As described so far, burrs that generate on the lead terminals 110, 111 can be reduced according to the aforementioned aluminum electrolytic capacitor 1 and method for manufacturing the same, and the same technique can also be applied to other electronic components having plate-shaped lead terminals. In fact, the aluminum electrolytic capacitor 1 and other capacitors are such that, the greater their capacitance, the higher the risk of burr-induced short-circuiting incidents becomes when burrs separate from the lead terminals 110, 111. For this reason, applying the aforementioned method to high-capacitance capacitors such as the aluminum electrolytic capacitor 1 is particularly useful.

The foregoing described the examples of the present invention in detail; however, the present invention is not limited to these specific examples and various modifications and changes can be made within the scope of the gist of the present invention as described in “What Is Claimed.”

### DESCRIPTION OF THE SYMBOLS

1 Aluminum electrolytic capacitor
10 Capacitor element
11 Case
12 Sealing body
13 Seat plate
22 Plating layer
90, 91 Outer die
92 Inner die
110, 111 Lead terminal
P, Q Burr

1. A method for manufacturing an electronic component, characterized by including a pressing step in which a lead terminal extending from an electric element is placed between a set of press dies along a length direction and processed into a plate shape,
wherein a surface contacting the lead terminal, of at least one of the set of press dies, has been blasted to form recesses and protrusions randomly on a plate face of the plate-shaped lead terminal.

2. The method for manufacturing an electronic component according to claim 1, characterized in that the lead terminal has a tin plating film.

3. The method for manufacturing an electronic component according to claim 2, characterized in that bismuth has been added to the tin plating film.

4. The method for manufacturing an electronic component according to claim 2, characterized in that an arithmetic mean surface roughness of the surface contacting the lead terminal, of at least one of the set of press dies, is 1.0 to 3.5 μm.

5. The method for manufacturing an electronic component according to claim 2, characterized in that an arithmetic mean surface roughness of the surface contacting the lead terminal, of at least one of the set of press dies, is about 1.6 μm.

6. The method for manufacturing an electronic component according to claim 5, characterized in that the surface contacting the lead terminal, of at least one of the set of press dies, has been blasted as mentioned above to bring an arithmetic mean surface roughness of the plate face of the lead terminal to between 1.1 and 2.0 μm.

7. The method for manufacturing an electronic component according to claim 5, characterized in that the surface contacting the lead terminal, of at least one of the set of press dies, has been blasted as mentioned above to bring a 10-point average surface roughness of the plate face of the lead terminal to between 7.0 and 15.0 μm.

8. The method for manufacturing an electronic component according to claim 1, characterized in that the electric element is a capacitor element.

9. An electronic component characterized by comprising an electric element and plate-shaped lead terminals extending from the electric element, wherein recesses and protrusions are randomly formed by surface roughening on plate faces of the lead terminals.

10. The electronic component according to claim 9, characterized in that the lead terminals have a tin plating film.

11. The electronic component according to claim 10, characterized in that bismuth has been added to the tin plating film.

12. The electronic component according to claim 9, characterized in that an arithmetic mean surface roughness of the plate faces of the lead terminals is 1.1 to 2.0 μm.

13. The electronic component according to claim 9, characterized in that a 10-point average surface roughness of the plate faces of the lead terminals is 7.0 to 15.0 μm.

14. The electronic component according to claim 9, characterized in that the electric element is a capacitor element.

15. A method for manufacturing an electronic component, comprising:
providing or offering an electric element having a lead terminal extending therefrom;
placing the lead terminal between a set of press dies along a length direction, wherein at least a surface of the set of press dies contacting the lead terminal has been surface-roughening treated; and
processing the lead terminal into a plate shape using the surface-roughened press dies, thereby forming recesses and protrusions randomly on a plate face of the plate-shaped lead terminal.
